(19) United States
(12) Patent Application Publication
(10) Pub. No.: US 2024/0380014 A1
(43) Pub. Date: Nov. 14, 2024

(54) METHOD OF OPERATING A LITHIUM BATTERY

(71) Applicant: BLUE SOLUTIONS, Ergue-Gaberic (FR)

(72) Inventors: Marc DESCHAMPS, Ergue-Gaberic (FR); Vincent BODENEZ, Ergue-Gaberic (FR)

(21) Appl. No.: 18/691,208

(22) PCT Filed: Oct. 5, 2022
(86) PCT No.: PCT/EP2022/077643

§ 371 Date: Mar. 12, 2024

(30) Foreign Application Priority Data
Oct. 6, 2021 (FR) FR2110587

(51) Int. Cl. H01M 10/44; H01M 10/052

(52) U.S. Cl. CPC H01M 10/446; H01M 10/052

(57) ABSTRACT

A method for operating a lithium battery, selected from solid or quasi-solid electrolyte lithium batteries, the lithium battery including at least one positive electrode, at least one solid or quasi-solid electrolyte, and at least one negative electrode, the method including that the charging and discharging temperatures are modulated so as to obtain a battery with improved cycling performance.

The present invention relates to the field of lithium batteries, more specifically to the field of solid or quasi-solid electrolyte lithium batteries and in particular to the field of Lithium-Met-Polymer (LMP) batteries, in particular used for the production of electric vehicles and/or the storage of intermittent power such as wind and/or solar power.

The invention relates more specifically to a method for operating a lithium battery within which the charging and discharging temperatures are modulated so as to obtain a battery with improved performance in terms of cycling resistance.

Lithium-metal-polymer batteries currently on the market (or LMP) are “all-solid-state” batteries generally in the form of a thin film wound several times, or several stacked thin films. This wound or stacked thin film has a thickness of the order of one hundred micrometers. It generally comprises at least four functional films: a negative electrode (anode) ensuring the supply of lithium ions during discharging, a positive electrode (cathode) acting as a receptacle where the lithium ions are inserted; a solid polymer electrolyte conducting lithium ions and located between the positive electrode and the negative electrode; and a current collector connected to the positive electrode to ensure the electrical connection. The negative electrode generally consists of a sheet of lithium metal or of a lithium alloy; the solid polymer electrolyte is generally composed of a polymer based on poly (ethylene oxide) (PEO) and at least one lithium salt; the positive electrode comprises an active electrode material, usually based on metal oxide (such as for example V₂O₅, LiV₃O₈, LiCoO₂, LiNiO₂, LiMn₂O₄ or LiNi_{0.5}Mn_{0.5}O₂) or based on a phosphate such as LIMPO₄ where M represents a metal cation selected from the group Fe, Mn, Co, Ni and Ti, and a combination thereof, and optionally carbon; and the current collector is generally made of a metal sheet.

The solid polymer electrolyte provides a great advantage in terms of safety since it bypasses the use of solvents that are potentially dangerous in the event of overheating. Such batteries can thus work at high temperatures without risks of explosion. However, the solid polymer electrolytes that are generally used, such as high molecular mass PEO doped with lithium salt, have low ionic conductivity at room temperature, their operating temperature must therefore be kept relatively high (typically between 70 and 100° C.). But at these temperatures, PEO becomes a viscous liquid and loses its dimensional stability.

The main areas of research therefore aim to modify the solid polymer electrolyte to obtain improved mechanical strength and ion conductivities maintained at lower temperatures.

In particular, Porcarelli et al. (Electrochimica Acta, 2017, 241, 526-534) describes polymer electrolytes of the polyurethane type obtained according to a polycondensation process in several steps from isophorone diisocyanate, polyethylene glycol and an anionic diol functionalized with an ester function and a sulfonyl (trifluoromethylsulfonyl) imide anion. In order to improve the mechanical and ionic conduction properties of the polymer material obtained, the latter is then functionalized with a crosslinkable function of methacrylate type and then crosslinked by UV irradiation to form a film which is then impregnated with propylene carbonate to form a gelified polymer electrolyte (quasi-solid electrolyte). However, the cycling resistance of the gelified polymer electrolyte obtained is not entirely satisfactory insofar as a decrease in capacity is observed beyond 10 cycles.

Thus, the aim of the present invention is to overcome the disadvantages of the aforementioned prior art and to provide a Lithium battery, and in particular a Lithium-Metal-Polymer (LMP) battery having good cycling stability (i.e. capable of operating over a large number of cycles). Indeed, increasing the growing of electric vehicles requires to be able to have batteries increasingly performing, in terms of cyclability.

The aim of the invention is achieved by the method for operating a lithium battery which will be described below.

The inventors of the present application have in fact surprisingly found that it was possible to differentiate the charging temperature and the discharging temperature during the operation of a lithium battery in order to improve its cycling resistance (also called cyclability), while guaranteeing the use of a solid or quasi-solid electrolyte having good ionic and mechanical conduction properties.

The first subject matter of the present invention is thus a method for operating a lithium battery chosen from lithium or quasi-solid electrolyte lithium batteries, said lithium battery comprising at least one positive electrode, at least one solid or quasi-solid electrolyte, and at least one negative electrode, said method being characterized in that it comprises at least the following steps:
i) a step of charging the lithium battery at a charging temperature Tc (in ° C.), and
ii) a step of discharging the lithium battery at a discharging temperature TD (in ° C.), and
characterized in that the charging temperature Tc (in ° C.) is strictly greater than the discharging temperature TD (in ° C.).

By implementing a charging temperature Tc greater than the discharging temperature T_{D}(T_{c}>T_{D}) (see steps i) and ii) of the method according to the invention), an improvement in the cyclability in solid or quasi-solid electrolyte lithium batteries is observed. This solution is easy to implement unlike the solutions of the prior art which aim to develop novel positive electrode active materials and/or novel polymer electrolyte materials.

Steps i) and ii)

In the present invention, the charging temperature T_{c} (respectively the discharging temperature T_{D}) is measured with a thermocouple of an oven, in particular sold under the trade name UNE500 by the company MEMMERT.

The charging temperature T_{c} (respectively the discharging temperature T_{D}) represents the temperature applied during the operation of the battery during charging (respectively during discharging).

During the discharge of the battery, the lithium detached from the negative electrode in Li+ionic form migrates through the solid or quasi-solid electrolyte (e.g. ionic conductive polymer) and is inserted into the active material of the positive electrode. The passage of each Lit ion into the internal circuit of the battery is exactly compensated by the passage of an electron into the external circuit, thus generating an electric current.

During the charging of the battery, the negative electrode will insert lithium into the material constituting it, and the positive electrode will release lithium. By virtue of the method of the invention, the deposition of lithium at the negative electrode is encouraged during charging. Steps i) and ii) of the method of the invention represent a charging-discharging process, also called cycling the lithium battery.

In a preferred embodiment, the difference between the charging temperature T_{c} during step i) and the discharging temperature T_{D} during step ii) (i.e. T_{c}−T_{D}) is of at least about 5° C., particularly preferably of at least 7° C. approximately, and more particularly preferably at least 10° C. approximately. Below a difference of 5° C., the cycling resistance is not sufficient.

In a preferred embodiment, the difference between the charging temperature T_{c} during step i) and the discharging temperature T_{D} during step ii) (i.e. T_{c}−T_{D}) is of at most 50° C. approximately, particularly preferably at most 40° C. approximately, more particularly of at most 30° C. approximately, and even more particularly preferably of at most 20° C. approximately. Above a difference of 50° C., the method becomes more difficult to implement (the battery heating up during charging and cooling down during discharging).

In a particularly preferred embodiment, the difference between the charging temperature T_{c} during step i) and the discharging temperature T_{D} during step ii) (i.e. T_{c}−T_{D}) ranges from 20 to 35°, and more particularly preferably from 25 to 30° C. approximately.

According to one embodiment of the invention, the charging temperature T_{c} during step i) ranges from 0° C. to 100° C. approximately, preferably from 10° C. to 95° C. approximately, and particularly preferably from 20° C. to 90° C. approximately.

The discharging temperature To during step ii) may range from −10° C. to 90° C. approximately, preferably from 0° C. to 85° C. approximately, and particularly preferably from 10° C. to 80° C. approximately.

It goes without saying that the charging T_{c} and discharging T_{D} temperatures may be in equivalent ranges of values, with the condition whereby the charging temperature T_{c} is strictly greater than the discharging temperature T_{D}.

The method for operating a lithium battery according to the invention can be applied to any type of lithium battery chosen from LMP batteries, whatever the nature of the active material in the composition of the positive electrode and/or whatever the nature of the solid or quasi-solid electrolyte.

In the present invention, the “solid or quasi-solid” electrolyte is in a solid form or in a gel form, at room temperature (i.e. 18-25° C.) and preferentially in solid form.

According to a preferred embodiment of the invention, reducing the operating temperature of the battery between the charging step i) and the discharging step ii) has no influence on the charge potential U_{c} during the charging step i) and the discharge potential U_{D} during discharge step ii) (i.e. no potential variation from U_{c} to U_{D} is observed that is linked to the variation in temperature from T_{c} to T_{D}).

Step i) can be carried out by heating the battery to the charging temperature T_{c} and by maintaining this temperature T_{c}, preferably until a state of charge of about 95% is obtained.

The temperature T_{c} is preferably constant during step i).

The heating of step i) can be carried out using at least one of the following heating means: Using hot pulsed air, using a heating liquid circuit, or one or more heating plates, and preferably using one or more heating plates.

Step ii) can be carried out by cooling the battery to the discharging temperature T_{D}.

The temperature T_{D} is preferably variable during step ii). It may for example reduce by a temperature T_{Dmax} at a temperature T_{Dmin}, it being understood that the charging temperature T_{c} (in ° C.) is strictly greater than T_{Dmax} and T_{Dmin} (in ° C.).

Cooling can be carried out by stopping the heating implemented at the end of step i) (i.e. after obtaining a state of charge of about 95%) or by forced cooling, and preferably by stopping the heating means implemented at the end of step i).

Cooling is generally carried out with low current (a period commonly called a “floating period”).

Forced cooling can be carried out using at least one of the following cooling means: Use of cold pulsed air, or use of a liquid cooling circuit.

### Other Steps

The method may further comprise repeating steps i) and ii) (i.e. performing a plurality of charge-discharge cycles).

The method may further comprise before step i) a step i₀) of discharging the lithium battery at a discharging temperature T_{D} (in ° C.), the charging temperature T_{c} (in ° C.) of step i) is strictly greater than the discharging temperature T_{D} (in ° C.) of step i₀). This embodiment is used when the battery is initially charged.

When the method of the invention comprises n charging steps and m discharge steps, n and m being integers strictly greater than 1, the charging temperatures T_{cn} during the charging steps (respectively the discharging temperatures T_{Dm} during the discharging steps) may be identical or different, and preferably identical.

The solid or quasi-solid electrolyte

The solid or quasi-solid electrolyte of the battery used in the method of the invention preferably comprises one or more polymer materials.

The polymer material (or the polymer materials when there are several of them) of the solid or quasi-solid electrolyte represent(s) preferably at least about 30% by mass, and particularly preferably at least 40% by mass approximately, relative to the total mass of the solid or quasi-solid electrolyte.

The solid or quasi-solid electrolyte may be a polymer electrolyte comprising:
at least one lithium salt and at least one polymer material based on poly (ethylene oxide) (PEO), or
at least one anionic polymer substituted with an anion of a lithium salt.

The polymer material based on poly (ethylene oxide) (POE) can be chosen from a polystyrene-poly (ethylene oxide) (PS-b-PEO) block copolymer, a polystyrene-poly (ethylene oxide)-polystyrene (PS-b-PEO-b-PS) block copolymer, a random poly (ethylene oxide-co-propylene oxide) copolymer (i.e. PEO-ran-PPO), a random poly (ethylene oxide-co-butylene oxide) copolymer (i.e. PEO-ran-PBO), a poly (ethylene oxide), and a mixture thereof.

The lithium salt used in combination with the polymer material based on poly (ethylene oxide) can be chosen from lithium fluorate (LiFO₃), lithium bis (trifluoromethanesulfonyl) imide (LiTFSI), lithium hexafluorophosphate (LiPF₆), lithium fluoroborate (LiBF₄), lithium metaborate (LiBO₂), lithium perchlorate (LiCIO₄), lithium nitrate (LiNO₃), lithium bis (fluorosulfonyl) imide (LiFSI), lithium bis (pentafluoroethyl) imide (LiBETI), LiAsF₆, LiCF₃SO₃, LiSbF₆, LiSbCl₆, Li₂TiCl₆, Li₂SeCl₆, Li₂B₁₀Cl₁₀, Li₂B₁₂Cl₁₂, lithium bis (oxalato) borate (LiBOB), and a mixture thereof.

The lithium salt preferably represents from 5 to 30% by mass, and even more preferably from 10 to 25% by mass, relative to the total mass of the polymer electrolyte.

Said polymer material based on poly (ethylene oxide) (POE) can be combined with a reinforcing agent. This thus makes it possible to modulate the mechanical properties of the polymer material.

Said reinforcing agent is preferably chosen from cellulose nanofibrils, ceramic nanoparticles such as titanium oxide, aluminum oxide or silicon oxide nanoparticles, and fluorinated polymers and copolymers such as polyvinylidene fluoride (PVdF) or the copolymer of vinylidene fluoride-hexafluoropropylene (PVdF-co-HFP).

The anionic polymer substituted by an anion of a lithium salt may be a block copolymer comprising at least one first block based on poly (ethylene oxide) and at least one second block based on an anionic polymer capable of being prepared from one or more monomers substituted by the anion of a lithium salt, such as sulfonyl (trifluoromethylsulfonyl) imide (TFSILi).

The block copolymer comprising at least one first block based on poly (ethylene oxide) and at least one second block based on an anionic polymer capable of being prepared from one or more monomers substituted by the anion of a lithium salt, already comprising anionic functions (anion of a lithium salt directly grafted in the structure of the polymer material). According to this embodiment, the polymer electrolyte then does not comprise additional lithium salt(s).

The monomer(s) is/are preferably chosen from vinyl and derivative monomers.

By way of example of vinyl monomers, mention may be made of lithium sulfonyl (trifluoromethylsulfonyl) imide styrene and derivatives thereof, in particular derivatives wherein the phenyl group of styrene is substituted by one or more groups chosen from methyl, ethyl, tert-butyl, a bromine atom and a chlorine atom, lithium sulfonyl (trifluoromethylsulfonyl) imide, lithium sulfonyl (trifluoromethylsulfonyl)imide methacrylate, lithium sulfonyl(trifluoromethylsulfonyl)imide acrylamide, lithium-sulfonyl (trifluoromethylsulfonyl)imide methacrylamide, lithium ethylene-sulfonyl(trifluoromethylsulfonyl) imide, lithium propylene-sulfonyl(trifluoromethylsulfonyl)imide, and lithium dienes-sulfonyl(trifluoromethylsulfonyl)imide dienes or lithium malemide-sulfonyl(trifluoromethylsulfonyl)imide)imide.

The polymer electrolyte may further comprise at least one plasticizer or a non-aqueous solvent. This thus makes it possible to form a gelified polymer electrolyte.

The solvent or plasticizer may be chosen from linear and cyclic carbonates such as propylene carbonate, ethylene carbonate or dimethyl carbonate; fluorinated carbonates such as fluoroethylene carbonate, nitriles such as succinonitrile, lactones such as y-butyrolactone, linear or cyclic polyethers, fluorinated polyethers, sulfur solvents such as sulfolane and dimethylsulfoxide.

Among such solvents or plasticizers, we may in particular cite dimethyl ether, polyethylene glycol dimethyl ether (or PEGDME) such as tetraethylene glycol dimethyl ether (TEGDME), dioxolane, ethylene carbonate (EC), propylene carbonate (PC), dimethyl carbonate (DMC), diethyl carbonate (DEC), methyl isopropyl carbonate (MiPC), ethyl acetate, ethyl butyrate (EB), and mixtures thereof.

Preferably, the solvent or plasticizer represents from 10% to 70% by mass approximately, even more preferentially from 20% to 60% by mass approximately, relative to the total mass of the polymer electrolyte.

The solid or quasi-solid electrolyte, the positive electrode, and the negative electrode are preferably in the form of films.

In lithium batteries operating according to the method of the invention, the thickness of the films that constitute the various elements of the battery is generally of the order of 1 to a hundred micrometers.

Preferably, the solid or quasi-solid electrolyte film has a thickness of 1 to 50 μm, and preferably of 2 to 20 μm.

The solid or quasi-solid electrolyte can be prepared by any technique known to a person skilled in the art such as, for example, by coating, extrusion or pressing (cold or hot).

The positive electrode

The positive electrode may comprise a positive electrode active material, optionally an agent generating electron conductivity, and optionally a polymeric material.

The active material of the positive electrode is a reversible active material of the lithium ions. In other words, lithium ions can be reversibly inserted or detached.

The positive electrode active material may be:
a metal oxide such as a vanadium oxide VOₓ (2≤x≤2.5), LiV₃O₈, Li_{y}Ni₁₋ₓCoₓO₂ (0≤x≤0≤y≤1), a manganese spinel Li_{y}Mn₁₋ₓMₓO₂ (M=Cr, Al, V, Ni, 0≤x≤0.5; 0≤y≤2), V₂O₅, LiCoO₂, LiNiO₂, LiMn₂O₄ and LiNi_{0.5}Mn_{0.5}O₂, or
a phosphosilicate or metal phosphate, for example LIMPO₄, where M represents a metal cation selected from the group Fe, Mn, Co, Ni and Ti, or a combination thereof, such as for example LiFePO₄, or
a metal sulfate, for example iron sulfate Fe₂(SO₄)₃.

The method of the invention is particularly suitable for LMP batteries, most particularly LMP batteries wherein the active material of the positive electrode is chosen from iron phosphate and its derivatives, in particular LiFePO₄.

The agent generating electron conductivity may be chosen from carbon blacks, SP carbon, acetylene blacks, carbon fibers and nanofibers, carbon nanotubes, graphene, graphite, metal particles and fibers of at least one conductive metal such as aluminum, platinum, iron, cobalt and nickel, and a mixture thereof.

The active material of the positive electrode may represent from 60 to 95% by mass approximately, and preferably from 70 to 90% by mass approximately, relative to the total mass of the positive electrode.

The agent generating electron conductivity can represent from 0.1 to 10% by mass approximately, and preferably from 0.3 to 5% by mass approximately, relative to the total mass of the positive electrode.

The polymer material may be a material chosen from ethylene homopolymers and copolymers, homopolymers and copolymers of propylene; homopolymers and copolymers of ethylene oxide (e.g. PEO, copolymer of PEO), methylene oxide, propylene oxide, epichlorohydrin, allyl glycidyl ether, and mixtures thereof; halogenated polymers such as homopolymers and copolymers of vinyl chloride, vinylidene fluoride (PVdF), vinylidene chloride, ethylene tetrafluoride or chlorotrifluoroethylene, copolymers of vinylidene fluoride and hexafluoropropylene (PVdF-co-HFP) or mixtures thereof; electronically non-conductive anionic polymers such as poly(styrene sulfonate), poly(acrylic acid), poly(glutamate), alginate, pectin, gelatin or mixtures thereof; cationic polymers such as polyethyleneimine (PEI), polyaniline in the form of emeraldine salt (ES), quaternized poly(N-vinylimidazole), poly(acrylamide-diallyldimethyl ammonium chloride) (AMAC) or mixtures thereof; polyacrylates; lithium salt anion-substituted anionic polymers; and a mixture thereof.

The anionic polymers substituted with an anion of a lithium salt are as defined in the invention.

The polymer material may in particular be a polymer material based on poly (ethylene oxide) (PEO) or an anionic polymer substituted by an anion of a lithium salt.

The active material of the positive electrode may represent approximately from 1 to 20% by mass, and preferably approximately from 5 to 15% by mass, relative to the total mass of the positive electrode.

According to a particularly preferred embodiment of the invention, the active material of the positive electrode is coated with a layer of carbon. The presence of the carbon layer makes it possible to improve the interface: active material-polymer material.

The carbon coating the active material preferably represents from 0.1 to 5% by mass approximately, relative to the mass of active material.

The carbon layer is preferably in the form of a layer with a thickness varying from 1 to 4 nm approximately.

The positive electrode may further comprise a lithium salt.

The lithium salt may be as defined in the invention.

The current collector

The lithium battery may further comprise a current collector connected to the positive electrode.

The current collector generally consists of a sheet of metal.

The current collector is preferably a current collector made of stainless steel or aluminum, optionally covered with a carbon-based layer (anti-corrosion layer).

The negative electrode

The negative electrode is preferably made of lithium metal, or by one of its alloys such as a lithium alloy with silicon, tin, aluminum or germanium.

The battery is then preferably an LMP battery.

The second subject matter of the invention is the use of a lithium battery chosen from lithium batteries with solid or quasi-solid electrolyte operating with a charging temperature T_{c} and a discharging temperature T_{D} such that the charging temperature T_{c} is strictly greater than the discharging temperature T_{D}, to improve its cycling resistance.

The lithium battery, the charging temperature T_{c}, and the discharging temperature T_{D} are as defined in the first subject matter of the invention.

The lithium battery as defined in the first subject matter of the invention is characterized in that it has a charging temperature T_{c} and a discharging temperature T_{D} and in that the charging temperature T_{c} is strictly greater than the discharging temperature T_{D}, the charging temperature T_{c} and the discharging temperature T_{D} being as defined in the first subject matter of the invention.

The present invention is illustrated by the following embodiments, to which it is not however limited.

### BRIEF DESCRIPTION OF THE DRAWINGS

The appended drawing illustrates the invention:

FIG. 1 shows the Faraday efficiency (as a percentage) based on the number of cycles (number) when the battery is operating by a method according to the invention and by a method of the prior art.

### EXAMPLE

The raw materials used in the examples are listed below:
carbon black Ketjenblack EC600JD, AkzoNobel,
LiFePO₄, Pulead,
PVDF-co-HFP, Solvay,
homo-PEO, Sumitomo Seika,
LiTFSI, Solvay,
aluminum current collector covered with a carbon layer, Armor,
lithium metal sheet, Blue Solutions.

Unless otherwise indicated, all the materials have been used as received from the manufacturers.

### Example 1: Preparation of an LMP Battery and Operation of Such an LMP Battery

### 1.1 Preparation of a Positive Electrode

A positive electrode in the form of a film was prepared in the following way: A mixture of 46 g of LifePO₄, 1.2 g of carbon black, 17.5 g of homo-PEO polymer material, 6.5 g of deionized water were introduced into a mixer sold under the trade name Plastograph® by the company Brabender®. The mixture was carried out at 60° C. at 80 revolutions per minute.

The paste thus obtained was then rolled at 60° C. on a carbon-coated aluminum current collector. The film obtained was dried for 10 minutes at 100° C. before being used.

The positive electrode obtained comprises 71% by mass of active material LFP, 27% by mass of homo-PEO polymer material and 1.9% by mass of carbon black. It has a thickness of about 45 μm.

### 1.2 Preparation of an LMP Battery

An LMP battery was prepared by assembling under a controlled atmosphere (dew point −50° C.):
a solid polymer electrolyte film with a thickness of 50 μm, comprising 80 g of polymer material (mixture of homo-PEO and PVDF-co-HFP) and 20 g of LiTFSI,
a sheet of lithium metal having a thickness of about 50 μm, and
of a positive electrode as prepared previously in point 1.1.

To do this, the sheet of lithium and the solid polymer electrolyte film are laminated at 70° C. and 5 bars to ensure good Li/electrolyte contacts, then finally the positive electrode is laminated at 70° C. and 5 bars on the Li/electrolyte assembly to form the battery. The electrolyte film is arranged between the metal film made of lithium and the positive electrode film. A conductive wire is connected to the lithium and another conductive wire is connected to the current collector of the positive electrode.

The lithium battery obtained has a sandwich-type structure and it is confined under vacuum in a pouch (informally known as a “coffee bag”) which corresponds to a heat-sealable waterproof package to protect it from moisture.

A lithium battery under a pressure of 1 bar is obtained.

### 1.3 Operating the LMP Battery

The battery obtained in point 1.2 was tested in an uncontrolled atmosphere. The lithium battery is then subjected to a plurality of charging-discharging processes (i.e. a plurality of steps i) and ii) repeated), the charging step i) being carried out at a charging temperature T_{c} of 90° C. and the discharging step ii) being carried out at a discharging temperature T_{D} of 50° C. (method according to the invention).

Step i) is carried out using a Memmert UNE500 oven.

By way of comparison, a lithium battery identical in terms of structure to that as prepared in point 1.2 above was subjected to a plurality of charging-discharging processes, the charging and discharging steps being carried out at an identical temperature of 80° C. (method not according to the invention).

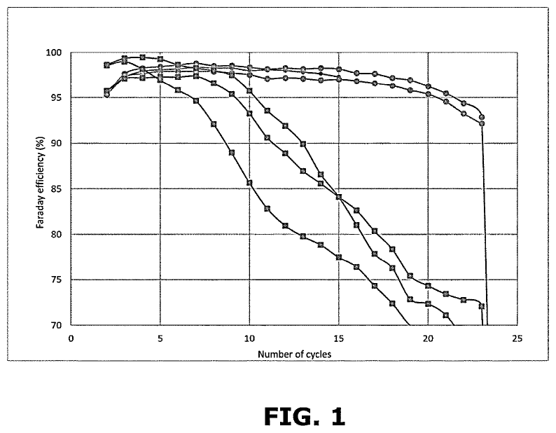

FIG. 1 shows the Faraday efficiency (as a percentage) as a function of the number of cycles (number) for the lithium battery operating according to a method of the invention (curve with the solid circles), and by comparison for the lithium battery not operating according to a method of the invention (curve with the solid squares).

The first cycle is carried out at C/10 (charging in 10 hours) and D/(10) (discharging in 10 hours) and the following cycles to C/4 (charging in 4 hours) and D/20 (discharging in 20 hours).

A very good cycling resistance over more than 20 cycles associated with a Faraday efficiency of 95% are obtained for the battery operating according to a method of the invention.

1. A method for operating a lithium battery chosen from lithium or quasi-solid electrolyte lithium batteries, said lithium battery comprising at least one positive electrode, at least one solid or quasi-solid electrolyte, and at least one negative electrode, said method comprising at least the following steps:
i) a step of charging the lithium battery at a charging temperature T_{c}; and
ii) a step of discharging the lithium battery at a discharging temperature T_{D}, the charging temperature T_{c} is strictly greater than the discharging temperature T_{D}.

2. The method according to claim 1, characterized in that the difference between the charging temperature T_{c} during step i) and the discharging temperature T_{D} during step ii) is of at least 5° C.

3. The method according to claim 1, characterized in that the difference between the charging temperature T_{c} during step i) and the discharging temperature T_{D} during step ii) is of at most 50° C.

4. The method according to claim 1, characterized in that the charging temperature T_{c} during step i) ranges from 0° C. to 100° C.

5. The method according to claim 1, characterized in that the discharging temperature T_{D} during step ii) ranges from −10° C. to 90° C.

6. The method according to claim 1, characterized in that it further comprises repeating steps i) and ii).

7. The method according to claim 1, characterized in that the solid or quasi-solid electrolyte is a polymer electrolyte comprising:
at least one lithium salt and at least one polymer material based on poly (ethylene oxide) (PEO), or
at least one anionic polymer substituted with an anion of a lithium salt.

8. The method according to claim 1, characterized in that the positive electrode comprises a positive electrode active material, optionally an agent generating electron conductivity, and optionally a polymeric material.

9. The method according to claim 1, characterized in that the negative electrode consists of lithium metal, or of one of its alloys.

10. The method according to claim 1, characterized in that the battery further comprises a current collector connected to the positive electrode.

11. A use of a lithium battery selected from lithium or quasi-solid electrolyte lithium batteries, said lithium battery comprising at least one positive electrode, at least one solid or quasi-solid electrolyte, and at least one negative electrode, said lithium battery operating with a charging temperature T_{c} and a discharging temperature T_{D} so that the charging temperature T_{c} is strictly greater than the discharging temperature T_{D}, to improve its cycling resistance.
